(19) United States
(12) Patent Application Publication
(10) Pub. No.: US 2017/0094982 A1
(43) Pub. Date: Apr. 6, 2017

(54) MULTI-TEXTURE COOKIE

(71) Applicant: GENERALE BISCUIT, Clamart (FR)

(72) Inventors: Cecile Roussel, Saclay (FR); Rui Borges, Saclay (FR); Pierre Aymard, Saclay (FR); Claude Sence, Saclay (FR)

(21) Appl. No.: 15/302,155

(22) PCT Filed: May 15, 2015
(86) PCT No.: PCT/EP2015/060807

§ 371 Date: Oct. 5, 2016

(30) Foreign Application Priority Data
May 28, 2014 (EP) 14170413.0

(51) Int. Cl. A21D 13/11; A21D 2/36; A21D 13/13; A21D 2/18

(52) U.S. Cl. CPC A21D 13/11; A21D 2/186; A21D 2/36; A21D 13/13

(57) ABSTRACT

The present invention relates to a cookie precursor comprising a first dough mix and a second dough mix, wherein the first dough mix comprises at least 20 wt % of flour, and wherein the second dough mix comprises 10 wt% or less of flour.

The present disclosure relates to a cookie product, a dough precursor for forming the cookie product and a method for producing the cookie. In particular, the disclosure relates to a cookie product that has a texture contrast similar to that of a freshly baked cookie, while achieving a long lasting shelf stability.

It is known that freshly baked cookies can have a highly desirable texture, but that this is lost over time due to staling and moisture loss. In particular, a fresh cookie may have a crispy or crunchy outer surface, but a chewy or even gooey centre. The centre may even have a texture approaching that of uncooked cookie dough. It is known, however, that such products do not maintain this dual texture on storage: moisture transfer and loss during storage lead to the product becoming dry and unappetising. For this reason, most long-term stable cookie products are often sold with a continuous crispy texture, or soft and chewy texture throughout, without a texture contrast.

Coextrusion methods for the manufacture of filled products are well known. Indeed, commonly available coextrusion machines are available from a number of machine suppliers which can coextrude materials for forming filled products, where a filling is entirely encompassed within an outer material. For example, U.S. Pat. No. 4,251,201 and U.S. Pat. No. 4,882,185 disclose standard coextrusion processes.

It is known to provide cookie products by coextruding two doughs. For example, U.S. Pat. No. 4,584,203, incorporated herein by reference, discloses a method of forming a cookie using two doughs. This allows for the provision of discrete regions of an inner dough which remain chewy and a continuous outer dough portion which is crispier. The inner dough is made more chewy by the addition of high fructose corn syrup (HFCS), which is a humectant, in a greater amount than in the outer dough. Other similar products are known from EP0181821 and EP0031718, which also rely on the use of humectants to provide a chewy inner dough.

Another approach is described in EP0208509, which provides a laminated product and wherein the inner chewy dough is provided by using a pregelatinized starch and a humectant. EP0219425 provides a multi-texture cookie where the chewy inner dough is provided by a humectant. The outer dough is made more crispy with casein and an edible water-soluble phosphate.

Other solutions to providing simultaneously a crispy and a chewy texture include using a fat filling, an internal barrier coating or addition of different ingredients such as inclusions, hydrocolloids, humectants, gums, crystallization inhibitors (like HFCS), to reinforce the crunchiness or the softness. These solutions can sometimes be detrimental to the appearance, taste and/or texture.

EP0372596 discloses cookies made with a low Aw filling. As discussed in Example 1, a single dough is formed and split into two portions. A first portion of the dough is flattened onto a cookie sheet, a jam-type filling without any flour is applied thereon, and then a second portion of the dough is flattened on top. The dough has a single texture consistency.

EP0136159 discloses baked products having stable properties characteristic of freshly-baked products. Example 2 discloses a composite cookie made from inner and outer doughs. The outer dough comprises 42wt % of flour (454 g of flour in 1084.9 g total), whereas the inner dough comprises 31 wt % of flour (354 g of flour in 1153.9 g total). The method mandates the inclusion of enzymes.

EP0219425 discloses a process and dough composition for producing multi-textured cookies. The cookie is formed from inner and outer doughs. The inner dough contains 28wt % of flour (100 parts of flour in 352.16 total parts). The outer dough contains 32wt % of flour (100 parts of flour in 314.02 total parts).

EP0181821 discloses a process and dough composition for producing multi-textured cookies. The cookie is formed from inner and outer doughs. The outer dough in Example 1 contains 36 wt % of flour (100 pounds of flour in a total formulation of 276.5 pounds). The inner dough contains 29 wt % of flour (100 pounds of flour in about 350 pounds total).

“Functionality of carbohydrate ingredients in bakery products” Food Technology, 45 (1991) March Vol. 3, discusses the roles of different sweeteners and starches in breads, cakes and cookies.

“Incorporation of corn fiber into sugar snap cookies” Cereal Chemistry, AACC International Inc. US, Vol 67, no. 3 1 May 1990 discloses recipes for sugar snap cookies and equipment for their preparation.

U.S. Pat. No. 4,219,580 discloses certain flour substitutes.

Therefore, one aim is to provide a cookie having a long shelf stability and a multi-texture that tackles the drawbacks associated with the prior art, or at least provides a commercial alternative thereto.

According to a first aspect, there is provided a cookie precursor comprising a first dough mix and a second dough mix, wherein the first dough mix comprises at least 20 wt % of flour, and wherein the second dough mix comprises 10 wt % or less of flour.

The present disclosure will now be described further. In the following passages different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous. In particular, aspects described with relation to the cookie precursor can be applied equally to the cookie and vice versa.

The terms “first dough”, “first dough mix”, “external dough” and “outer dough” are used interchangeably in this disclosure. These terms are used to refer to the dough which forms, after baking, the crispy and crunchier portion of the multi-texture cookie described herein. Similarly, the terms “second dough”, “second dough mix”, “internal dough” and “inner dough” are used interchangeably in this disclosure. These terms are used to refer to the dough which forms, after baking, the softer and chewy portion of the multi-texture cookie described herein.

As will be appreciated, a “dough” (or the synonymous “dough mix”) refers to the hydrated malleable formulation which is ready to be baked and does not include dry mixes of the ingredients per se.

By the term “flour” is meant the powder obtained by grinding or milling cereals such as wheat, oat, barley, rye, rice, corn, millet and the like and pseudo-cereals such as buckwheat and quinoa. The flour can be a “whole” flour, that is to say, a ground or milled grain whose principal components—the starchy endosperm, the germ and the bran—are present in the same relative proportions as they are in the intact grain.

Preferably, the flour is a wheat flour, that is to say, the product prepared from wheat grain by grinding or milling processes in which the bran and germ are at least partially removed and the portion that remains is ground to a suitable degree of fineness. In the context of the present disclosure, the term “flour” does not include extraneous starches such as corn starches or modified starches.

By the term “starches” it is meant extraneous starches, that is to say, starches that are added to the dough mix separately and do not form part of the flour or any other component of the inner dough. Starches are carbohydrates comprising a large number of glucose units joined by glycosidic bonds. Common sources of starches include potatoes, wheat, corn and rice. Native starches are those which are not modified following isolation from their source, such as native potato starch.

In the native form, starches are present as partially crystalline “granules” that are insoluble in water. Upon heating in water, the granules swell and burst, the semi-crystalline structure is lost and the more linear amylose molecules start leaching out of the granule, increasing the mixture's viscosity. This process is called starch gelatinization. During cooking, the starch becomes a paste and increases further in viscosity. A native starch has not been gelatinized. By contrast, a pregelatinized starch, such as a pre-cooked starch, has been at least partially gelatinized. Pregelatinized starches, such as pregelatinized corn starch, are commercially available.

Other types of starches include modified starches, that is, a starch that has been modified to allow enhance function under conditions frequently encountered during processing and storage. These modifications can be achieved by, for example, acid treatment, alkali treatment, oxidation, acetylation and the like. Modified starches are commercially available.

By the term “sugars” is meant simple sugars (degree of polymerisation=1) such as glucose and fructose, as well as disaccharides (degree of polymerisation=2) such as sucrose and maltose. The term “sugars” as used herein does not include “oligosaccharides”, which are digestible carbohydrates having a degree of polymerisation of 3 or above. A suitable source of such oligosaccharides is glucose syrup, which contains sugars as well as oligosaccharides (maltotriose DP3, maltotetraose DP4, etc). In most glucose syrups, the oligosaccharides fraction contains oligosaccharides having degrees of polymerisation of from 3 to about 100 for a poorly hydrolyzed syrup (low “dextrose equivalent”-DE-) and of from 3 to about 10 for a more hydrolyzed syrup (high DE). As will be appreciated, the sugar content of glucose syrup will vary depending on the source. Based on the source, the desired amounts for inclusion in a dough mix can be calculated.

By the term “cookie” is meant a sweet biscuit. Cookies are well known in the art and are typically made from flour, eggs, sugar and oil. The presence of eggs is not essential. They are often found with one or more inclusions, such as chocolate chips or raisins. Freshly baked or home-made cookies typically have a crisp outer surface and a gooey centre. Some commercial cookies tend to have a harder aspect throughout.

A cookie precursor is, therefore, the dough which, when baked, provides a cookie. The inventors have found that it is possible to provide a long shelf-life cookie product with a crunchy outer region and retaining one or more inner chewy regions. The inventors have found that this can be achieved by coextruding two different dough formulations. Surprisingly, they found that the shelf stability, particularly the stability of the dual texture, of this product is greatly enhanced by the control of the flour content of the two doughs. Moreover, the substitution of the flour from the inner dough with starches and fibers allows both a large difference in the moisture between the inner and outer dough portions, and maintains this difference stably during long term storage.

The method described herein contemplates two approaches to maximise the dual texture distinctions. The first is to increase the crispness and crunchiness of the outer dough. The inventors found that this can be achieved by, for example, (i) increasing the flour content, and/or (ii) adding certain starches, such as pea starch, and/or (iii) adding egg components, and/or (iv) varying the sugar composition (increasing the amount of mono and disaccharides relative to oligosaccharides).

The second is to decrease the crispness and crunchiness (i.e. increase the softness) of the inner dough. The inventors found that this can be achieved by developing a dough with a low flour content. It has been found that the use of a low flour content is aided by certain measures to improve the workability of the remaining formulation, such as replacing the flour with a mix of starches and fibers, and incorporating certain fats into the dough. In addition, it was possible to increase the softness by reducing crystallisation in the inner dough mixture. This could be achieved by reducing the amount of sugars relative to the amount of oligosaccharides, and by adding humectants such as glycerol.

Thus, the cookie precursor comprises a first dough mix which comprises at least 20 wt % of flour. Preferably the first dough mix comprises from 30 to 80 wt % flour, preferably from 30 to 50 wt %, more preferably about 40 wt %. This provides a workable dough and a crunchy final outer surface to the biscuit.

The cookie precursor comprises a second dough mix which comprises 10 wt % or less of flour. Preferably the second dough mix comprises less than 5 wt % flour, more preferably less than 1 wt % flour, and, more preferably still, substantially no flour. The low flour content has been found to be critical to ensuring that the inner dough is soft and remains soft during long term storage.

In softening the inner dough, it is necessary to ensure that the dough has a suitable rheology for use in the manufacture process and is sufficiently cohesive and workable for extrusion, despite the low flour content. The approach adopted was to control the dough texture during the manufacture at the process temperature. This could be achieved by selecting the non-lipid ingredients which structure the dough such as a blend of starches and by using insoluble fibre with high water retention capacity.

In particular, it was found that certain insoluble dietary fibers, such as soy fibers, aided this approach and it was considered, without wishing to be bound by theory, that this was the result of a high water retention capacity of those fibers. Certain sources of dietary fibers, such as cocoa powder, or fruit and vegetable extracts such as apple, citrus, tomato and/or carrot pomace powders or tuber extracts, such as potato fibers, could also be used to this effect. It was also found that certain non-viscous soluble fibers, such as acacia gum, provided a moist mouthfeel.

Preferably the second dough mix contains fibers in an amount such that the amount by weight included in the second dough mix multiplied by the water holding capacity (WHC) of the fiber is at least 10. Preferably this value is at most 13, more preferably at most 12. The measurement of WHC is described below. The greater the WHC of the starches and fibers selected, the better their binding capacity and the better the consistency of the second dough. Thus, starches and fibers having a relatively high WHC need to be used in lower amounts to achieve an equivalent effect.

It was found that certain starches increased the viscosity of the dough, preventing excessive spreading and leakage of the inner dough during processing. These starches preferably comprise a blend of native starch and pregelatinized starch. These starches provide a softer dough texture than could be obtained without flour replacement, and reduced degradation of the finished product throughout its shelf-life. Preferably, the blend comprises native potato starch and pregelatinized corn starch. This was found to impart a soft texture to the centre of the resulting cookie that is maintained throughout its shelf-life. The starches and fibers are preferably extraneous.

Thus, preferably the second dough mix comprises one or more starches and/or fibers, preferably in a total amount of from 5 to 20 wt %, preferably from 10 to 20 wt %. Preferably the starches and/or fibers comprise a blend of native starch and pregelatinized starch, and/or soy fibers and/or cocoa powder.

As explained previously, another means of controlling the dough texture during manufacture was through careful choice of added fat ingredients. In particular, it was found that the use of high SFC fat (e.g. having an SFC of at least 20 wt % at 20° C.), such as cocoa butter or shea stearin, in addition to palm oil, allowed the texturing of the soft inner dough and made it especially suitable for the co-extrusion process. This allowed the formation of a lower dough density in the region of 0.8-1.0 g/cm³.

Preferably the second dough mix comprises cocoa butter in an amount of from 2 to 14 wt %, more preferably from 8 to 14 wt %, more preferably still from 10 to 12 wt %. The inventors have found that the use of cocoa butter in the formulation is particularly desirable because the cocoa butter helps to make the second dough stiffer and more workable and prevents the dough being too thin or fluid. In addition, it affects the amount of air which can be retained in the dough on mixing. The cocoa butter may be provided as an isolated fat. Alternatively, the cocoa butter may be formed in situ through the addition of chocolate mass and cocoa powder to the dough mix.

The added fats preferably comprise a blend of palm oil and cocoa butter.

The Solid Fat Content (SFC) of the blend of fats included in the second dough mix at 20° C. is preferably at least 20 wt %, more preferably at least 30 wt %, and preferably less than 60 wt %. It has been found that through the addition of blends having such SFC values, it is possible to provide an inner dough with sufficient rigidity for coextrusion at the process temperature, without compromising the soft texture required in the final product. SFC measurements are well known in the art and are disclosed in U.S. Pat. No. 4,840,803, the content of which is incorporated herein by reference.

Accordingly, the present inventors have developed a food composition for the inner dough which is neither a filling nor a standard dough. It is not a filling because it does contain baking powders and therefore rises during baking. It is not a standard dough because it does not contain flour or only a small amount (<10 wt %). This has been achieved by identifying a mix of starches and fibers that give rise to a soft, shelf-life stable continuous dough and by avoiding using flour, which would degrade over time and give an evolving texture and moisture content. In particular, there is achieved a typical moisture difference between outer and inner dough of at least 30 wt %, even if the inner dough is not fully encompassed by the outer dough after baking. This is achieved without the use of barrier film or any other technology aiming at limiting moisture migration.

Preferably the second dough mix forms one or more discrete regions within the first dough mix. Preferably the second dough mix is entirely encompassed by the first dough mix.

It has been found that the use of two dough formulations as described herein does not lead to any visible transition between the outside and inside of the cookie. This helps to maintain the impression of a “freshly-baked” product.

Preferably the precursor is approximately disc-shaped and, preferably, has a diameter of from 4 to 5 cm, although larger and smaller precursors are contemplated. Preferably the cookie precursor has an outer peripheral portion comprising the first dough mix and an inner central portion comprising the second dough mix. The level of spreading during baking is determined by the formulation and lies within a standard cookie range. Preferably the weight of the cookie after baking is approximately 23 to 30 g without toppings.

Preferably the cookie precursor further comprises one or more regions of a third dough mix. The presence of a third dough mix can be used to add one or more regions having a further texture. For example, a softer centre could be provided or, alternatively, a centre having a different flavour or colour could be provided, but having a similar texture to the second dough.

Preferably the ratio by weight of the first dough mix to the second dough mix is from 80:20 to 50:50, more preferably from 70:30 to 60:40. The use of equal or larger amounts of the first dough helps to make the precursor more dimensionally stable during processing and during baking. Where the amount of the second dough is more than 50 wt %, the risk of the softer dough spreading is increased.

Preferably the first dough mix further differs from the second dough mix by at least one of flavouring and/or colouring. The presence, for example, of cocoa powder in one or other of the dough mixes allows for a darker or lighter portion to be formed. Even so, the inventors have found that with such formulations there is no clear border between the dough regions in the final product, such as is present with cookies having internal borders.

Preferably the first dough mix comprises fats in an amount of from 10 to 20 wt %; and/or sugars in an amount of from 5 to 30 wt %, preferably from 20 to 30 wt %. These amounts of fat and sugar provide a suitable dough, without compromising the machinability of the dough.

Preferably the second dough mix comprises fats in an amount of from 15 to 35 wt %, preferably from 15 to 25 wt %; and/or sugars in an amount of from 10 to 25 wt %, preferably from 17 to 23 wt %; and/or oligosaccharides in an amount of 10 to 25 wt %, preferably from 17 to 23 wt %. These amounts of fat and sugar provide a suitable dough, without compromising the machinability of the dough. The amount of sugar and fat in the second dough mix can be greater than for the first dough mix because of the lower flour content and the use of the starches and fibers.

While sweet formulations have been discussed above, the product may alternatively possess both sweet and savoury sensory attributes. Thus, the first dough mix may be savoury, and the second dough mix may be sweet but with a savoury flavouring.

A savoury flavour may be imparted to the second dough mix by including dried cheese powder in the second dough mix, preferably in an amount of from 4 to 8 wt %. When dried cheese powder is included, the amount of sugars present in the second dough mix may be decreased, for example to 10-20 wt %, preferably to 10-17 wt %. The first dough mix in this embodiment is typical of a cracker dough, having low levels of sugar and high levels of flour. In this embodiment, the processability of the first and second dough mixes is such that they are preferably double sheeted rather than coextruded.

The inventors performed detailed testing on the rheology of the first and second dough mixes. This was to characterize the dough mixes at room temperature (after mixing) and upon heating (to mimic baking) using a combination of techniques (compression and small-strain oscillatory measurements). They concluded that the use of starches and fibers, especially pre-gelatinized starches, has a role to control the evolution of rheology upon heating. When replaced by flour, some softening impact is observed at room temperature but there is especially a dramatic loss in texture upon heating. This thinning explains why the inner dough leaks out the product during baking, leading to unacceptable products.

As discussed above, the inventors have found that certain starches have a structuring role. They contribute to a dough rheology at ambient temperature that is compatible with the co-extrusion process. Cocoa butter also contributes to have a dough rheology at the process temperature that fits to the co-extrusion process. The low density obtained with palm-oil-based dough is, by contrast, detrimental to the co-extrusion process, since it increases the volume of the inner dough, increases the dough's elasticity and may lead to excessive oven-raise during baking.

The first and/or second dough mixes preferably comprise added sugars and added oligosaccharides. The inventors have surprisingly found that it is possible to increase the crispness and crunchiness of the outer dough by using a large amount of sugars (that is, mono and di-saccharides) in the dough relative to oligosaccharides. Thus, the first dough mix preferably comprises added sugars in an amount of at least 80 wt %, preferably at least 90 wt %, more preferably at least 95 wt %, and preferably at most 99.9 wt %, by weight of the total added sugars and oligosaccharides in the first dough. It has further been found that it is possible to increase the softness of the inner dough by using a reduced amount of sugar relative to the oligosaccharide content of the dough. Thus, the second dough preferably comprises added sugars in an amount of less than 80 wt %, preferably less than 65 wt %, more preferably less than 55 wt %, and preferably at least 35% by weight of the total added sugars and oligosaccharides in the second dough.

Preferably the second dough mix comprises one or more humectants and/or acacia gum. These ingredients have been found to increase the moist mouthfeel. Moreover, the use of humectants, such as glycerol, in place of readily crystallized sugars and increasing the proportion of oligosaccharides relative to monosaccharides helps to provide a soft inner dough and a final product that is stable throughout its shelf-life.

Preferably the ratio of the F_{AV} values of the first dough mix to the second dough mix is at least 3:1 and preferably from 3:1 to 8:1. The measurement of this parameter is discussed below. The inventors have found that this ratio reflects a measure of the final consistency and texture difference between the inner and outer portions of the cookie product. That is, the greater the F_{AV} ratio, the more chewy the centre compared to the crispy outer surface.

Preferably the first and/or second dough mix further comprises a plurality of inclusions in an amount of from 5 to 25 wt %, preferably from 5 to 15 wt %, by weight of the dough mix, preferably selected from nuts, jellies, nougat, honeycomb, flavoured chips such as chocolate chips, coconut, toffee, oats, seeds, caramel, fudge, hard candy, marshmallows, cherries, raisins and dried fruit, or mixtures of two or more thereof. These add a further textural dimension to the product.

Preferably the cookie precursor further comprises a topping in an amount of from 5 to 25 wt %, preferably from 5 to 15 wt %, by weight of the cookie precursor, wherein the topping is preferably selected from a glaze, a coating, such as a chocolate or yoghurt coating, nuts, jellies, nougat, honeycomb, oats, seeds, flavoured chips such as chocolate chips, coconut, toffee, fudge, hard candy, marshmallows, cherries, raisins and dried fruit, or mixtures of two or more thereof.

According to a second aspect there is provided a cookie obtainable by baking the cookie precursor disclosed herein.

Preferably the cookie is shelf stable for at least 6 months when stored at 20° C., and preferably at least 9 months when stored at 20° C.

The water activity (Aw) of a product is a notion which is well known in the food industry field. This value measures the availability of water in a sample. In most cases, this water activity is not proportional to the water content of the product. Methods for measuring Aw of a product are known to the person skilled in the art.

For example, it can be measured with an Aqualab CX-2 or series 3, or a Novasina. All Aw values indicated hereafter are measured at 25±0.1° C.

Typically, crispy products have a low moisture of less than 4 wt % and a low Water Activity (Aw) of less than 0.3. To the contrary, soft products usually have a high moisture of at least 10 wt % and an Aw of more than 0.65. When you combine crispy and soft products, an equilibrium is established whereby the product is neither satisfactorily crispy or soft. The inventors have found that the product can have a total moisture content and Aw between these typical values, because by avoiding the inclusion of flour but still providing a workable dough formulation, the texture contrast can be maintained for a long shelf life due to water and Aw remaining stable.

The cookie produced with the method described herein preferably has a final moisture content between 5 wt % and 9 wt % and a final Aw between 0.44 and 0.6. Importantly, this dual texture can be maintained for at least 6 months and preferably at least 9 months of shelf storage since even when the Aw equilibrium is reached, regions of greater and lower moisture content are maintained. For instance the cookie of Example 1 has an average moisture content of 7.1 wt % and more specifically a moisture content of 5.7 wt % in the external dough and of 9.6 wt % in the inner dough. This corresponds to a moisture content difference of 70% while the Aw is equivalent and equal to 0.5 in both doughs. Preferably the cookie has an Aw of from 0.45 to 0.55. Preferably the cookie has a moisture content of from 5 to 8 wt %, more preferably from 7 to 8 wt %.

According to a third aspect there is provided a method for forming a cookie precursor, the method comprising:
providing a first dough mix and a second dough mix,
forming a cookie precursor from the first and second dough mixes,
wherein the first dough mix comprises at least 20 wt % of flour, and
wherein the second dough mix comprises 10 wt % or less of flour.

Preferably the method of making a cookie precursor of the third aspect is for making the precursor of the first aspect.

Preferably the first dough mix and the second dough mix are coextruded to form the cookie precursor. The disclosure provides a solution by replacing the flour in the internal dough to get this contrast of texture with the external dough and provide a long shelf life without having any issues during the process (co-extrusion, baking, cooling). From a processing standpoint co-extrusion is preferred since it is efficient and reproducible. Nonetheless, a sheeting technology could be used, whereby the inner dough is sandwiched between layers of the outer dough.

Preferably the method further comprises baking the cookie precursor to form a cookie.

Preferably the method further comprises (i) applying a coating and/or filling to the cookie; and/or (ii) packaging the cookie.

Preferably the cookie disclosed herein is not a filled cookie. That is, the final product does not contain a liquid ingredient, but instead has an apparently continuous texture between the inner and outer portions after baking.

In one embodiment the cookie is prepared with gluten-free flour. This makes the product suitable for consumption by those with a gluten intolerance. Moreover, due to the specific composition of the inner dough, the recipe is not unduly affected by the use of gluten-free ingredients.

It was found that the dual texture cookie structure, as described herein, further required some specific adjustments to the baking and cooling profiles as shown in the examples.

### FIGURES

The present disclosure will be described in relation to the following non-limiting figures, in which:

FIG. 1 is a cross-section through a cookie of Example 1.

FIG. 2 is a bar chart illustrating the elastic moduli of the doughs of the Examples at 22° C. and at 90° C.

FIG. 3 is a flowchart illustrating the different steps of one embodiment of the method for producing a cookie as described herein.

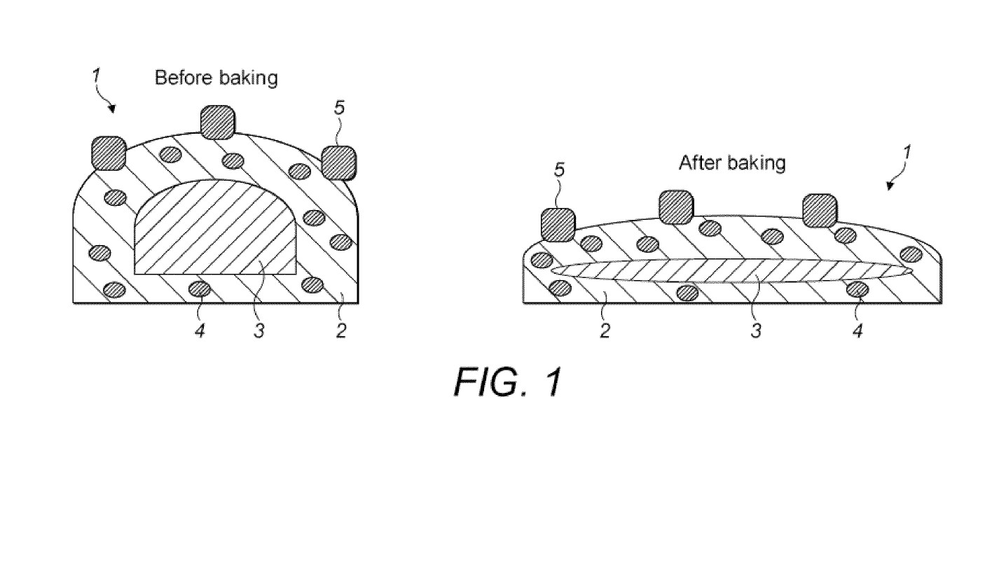

FIG. 1 shows a cookie 1, formed from an outer dough 2, and inner dough 3 and having chocolate pieces as an inclusion 4 and a topping 5. The cookie 1 shown has an outer diameter of 72 to 76 mm and a weight of about 30-33 g, including toppings.

The inner dough has a soft, dense texture and forms 30-40 wt % of the dough portion of the product, whereas the outer dough has a crusty texture and forms 60 to 70 wt % of the dough portion of the product. In this example, there are additional chocolate drops incorporated into the external dough only.

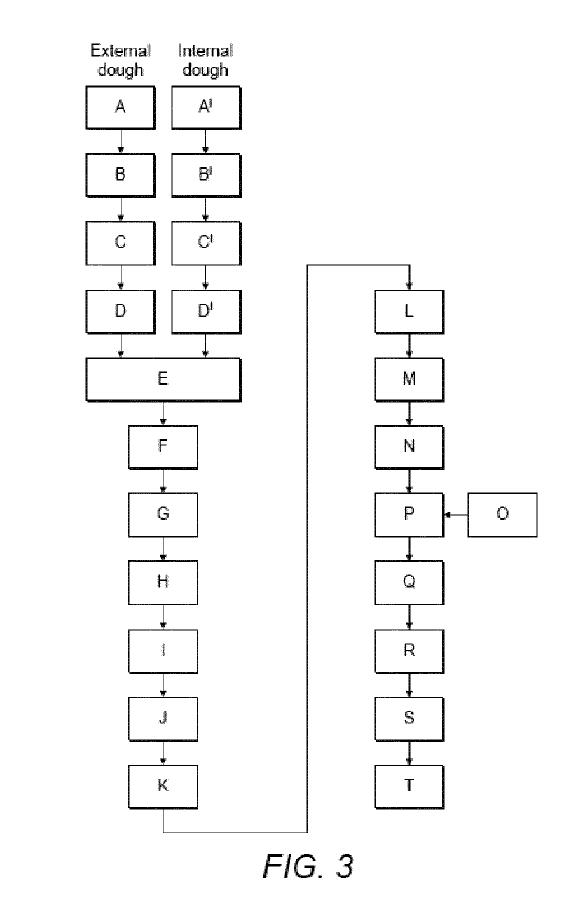

In FIG. 3, the reference letters are as follows:

A, A′—Dosing

B, B′—Mixing

C, C′—Dough Transfer

D, D′—Resting time

E—Coextrusion

F—Iris cutting

G—Calibration roller

H—Glazing

I—Topping deposition

J—Roller

K—Transfer

L—Baking

M—Cooling

N—Transfer

O—Cardboard tray

P—Flowpack

Q—Casing

R—Pallet

S—Storing

T—Transport

### EXAMPLES

The present disclosure will now be described in relation to the following non-limiting examples.

In the following examples, first and second dough mixes were prepared. These were coextruded to provide a cookie precursor where the first dough formed an external dough portion of the precursor. The second dough formed an internal portion of the dough.

The doughs were coextruded so that the internal dough formed the central region of the dough. The extruded doughs were cut into cookie sized and shaped pieces with an iris cutter; this smears the external dough sufficiently to substantially encapsulate the internal dough. An example of the suitable apparatus used is disclosed in U.S. Pat. No. 4,584,203. The cookie precursors were sized between 40 and 50 mm and were spherical.

The cookie precursors were then baked for a time and under conditions sufficient to provide a baked cookie. The cookies weighed on average 33 g.

### Example 1

A cookie was prepared with dark chocolate inclusions. This recipe was found to provide an excellent dual texture consistency. No visible line could be seen in the final product to demark between the internal and outer doughs.

| | wt % |
|---|---|
| | Dough |
| | before |
| | baking |
| EXTERNAL DOUGH | 49.08% |
| INTERNAL DOUGH | 41.72% |
| TOPPING | 9.20% |
| TOTAL | 100.00% |

| External Dough | wt % in dough |
|---|---|
| Wheat Flour | 40.01% |
| Palm oil | 16.00% |
| Dark chocolate chips | 10.00% |
| Sugars | 24.00% |
| Liquid whole egg | 6.40% |
| Glucose syrup | 0.32% |
| Salt | 0.24% |
| Baking agents | 0.46% |
| Flavour | 0.15% |
| Water | 2.40% |
| Total before baking | 100.00% |

| Internal Dough | wt % in dough |
|---|---|
| Palm oil | 10.39% |
| Cocoa butter | 10.39% |
| Starches | 12.19% |
| Sugars | 15.6% |
| Liquid whole egg | 13.98% |
| Glucose syrup | 23.97% |
| Glycerol | 10.69% |
| Flavour | 0.14% |
| Soy fiber | 2.20% |
| salt | 0.21% |
| baking agents | 0.29% |
| Total before baking | 100.00% |

The starches contained native potato starch and pregelatinized corn starch.

In the tables, the term “sugars” refers to mono and disaccharides (DP1 and DP2, where DP stands for “degree of polymerization”).

Glucose syrup contains sugars as well as oligosaccharides (maltotriose DP3, maltotetraose DP4, etc). The ratio of sugars over the sum of sugars and oligosaccharides, i.e. sugars/(sugars+oligosaccharides) is key to the texture contrast. In the external dough of Example 1, the value of this ratio is 99.6%, while the ratio is only 52% for the internal dough. The glucose syrup used in this Example contained around 30% sugars based on dry mass, the remainder being oligosaccharides.

The topping used in this Example was chocolate drops/chunks.

The following process of production was used:

External Dough Mixing

The mixing of the external dough is done using a conventional mixer type. The mixing process starts with the mixing of the fat, the sugars and other powder ingredients (out of flour and baking powders). Then the liquid ingredients are added, subsequently the flour and the baking powders are added and blended until a homogeneous dough is obtained. Finally, the chocolate drops are added and blended with the dough. The dough water activity is approximately 0.78.

Internal Dough Mixing

The mixing of the internal dough is done using a conventional mixer type. The mixing process starts with the mixing of the fats, the sugars and other powder ingredients (out of the baking powders). Then the liquid ingredients are added, subsequently the starches, the fiber and the baking powders are added and blended until a homogeneous dough is obtained. The dough water activity is approximately 0.73. The density of the dough is approximately 0.9.

Coextrusion of the Two Doughs

The two doughs are co-extruded with a conventional co-extrusion machine. The nozzles are designed to allow the targeted relative proportions of the external and internal dough to be reached. The coextruded row is cut with a conventional Iris cutter (diaphragm cutter) in order to obtain a co-extruded dough piece with the internal dough entirely encrusted in the external dough. The coextrusion of Example 1 was carried out at a process temperature of 18° C. In general, a suitable process temperature is from 15 to 25° C., preferably from 16 to 20° C. The process temperature may be chosen in accordance with the specific fat blend used.

Calibration and Glazing

The dough pieces are calibrated in height with a roller. A glazing is added on top of the dough pieces.

Topping Depositing

Chocolate and/or other pieces are added as a topping on top of the surface of the dough pieces surface using a specific depositor. A roller pushes the deposited pieces slightly into the dough.

Baking

The dough pieces are baked using a baking profile (a temperature of approximately 200° C. for 10 min) allowing the target product characteristics to be met in terms of colour, diameter, global moisture and water activity after cooling.

The products are quickly packed in an aluminium film or any other water barrier pack.

After equilibration the moisture of the external dough is 5.7 wt % with Aw 0.49 and the moisture of the internal dough is 9.6 wt % with Aw 0.5 which correspond on the total cookie to a total moisture at 7.1 wt % with an Aw of 0.5.

The products have a shelf life of over 6 months.

### Example 2

A cookie was prepared with a dark chocolate centre. This recipe was found to provide an excellent dual texture consistency. The central region of the cookie, which was entirely encapsulated within the lighter outer dough, provided a clearly darker chewy region.

The ratios and the composition of the external dough are the same as in example 1. The composition of the internal dough was as follows:

| Internal Dough | wt % in dough |
|---|---|
| Palm oil | 17.63% |
| Starches | 10.70% |
| Sugars | 8.6% |
| Liquid whole egg | 13.93% |
| Glucose syrup | 23.65% |
| Glycerol | 10.61% |
| Chocolate | 9.16% |
| Flavour | 0.13% |
| salt | 0.18% |
| baking agents | 0.29% |
| Cocoa powder low fat | 5.13% |
| water | 0.00% |
| Total before baking | 100.00% |

The starches contained native potato starch and pregelatinized corn starch.

The topping was chocolate drops/chunks.

To produce this cookie, the same process steps as above are essentially followed, the only difference being that the liquid chocolate is added in the internal dough after mixing fats, sugars and other powder ingredients and before addition of liquid ingredients.

In Example 2, after baking, we see a difference of texture and colour between the two doughs.

### Example 3

A cookie was prepared with dark chocolate inclusions. This recipe was found to provide an excellent dual texture consistency throughout the shelf life of the product. The ratios are the same as in example 1.

| External Dough | wt % in dough |
|---|---|
| Wheat Flour | 37.66% |
| Concentrated butter | 15.06% |
| Dark chocolate chips | 15.06% |
| sugars | 22.59% |
| Liquid whole egg | 6.03% |
| Glucose syrup | 0.30% |
| Salt | 0.50% |
| Baking agents | 0.44% |
| Flavour | 0.10% |
| Water | 2.26% |
| Total before baking | 100.00% |

| Internal Dough | wt % in dough |
|---|---|
| Palm oil | 11.00% |
| Cocoa butter | 15.00% |
| Starches | 5.80% |
| sugars | 15.6% |
| Liquid whole egg | 14.00% |
| Glucose syrup | 24.00% |
| Glycerol | 10.70% |
| Soy fiber | 3.00% |
| salt | 0.50% |
| baking agents | 0.29% |
| Flavour | 0.10% |
| Total before baking | 100.00% |

The starches contained native potato starch and pregelatinized corn starch.

To produce this cookie, the same process steps as those detailed above were followed.

After equilibration, the moisture of the external dough is 4.6 wt % with Aw 0.49 and the moisture of the internal dough is 6.5 wt % with Aw 0.49, thus producing a cookie with a total moisture of 5.5 wt % with an average Aw of 0.49.

### Example 4

A cookie was prepared having a sweet inner dough with a savoury flavouring and a savoury outer dough, in accordance with the invention.

The external dough recipe is typical of a cracker dough.

| | wt % Dough |
|---|---|
| | before baking |
| EXTERNAL DOUGH | 63% |
| INTERNAL DOUGH | 37% |
| TOTAL | 100% |

| External Dough | wt % in dough |
|---|---|
| Wheat flour | 74.84% |
| Palm oil | 7.48% |
| Sugars | 3.12% |
| Malt | 7.48% |
| Glucose syrup | 4.69% |
| Salt | 1.30% |
| Baking agents | 1% |
| Processing aids | 0.09% |
| Water | 18.22% |
| Total before baking | 100.00% |

| Internal Dough | wt % in dough |
|---|---|
| Palm oil | 13.49% |
| Cocoa butter | 7.49% |
| Dried cheese powder | 6.59% |
| Starches | 11.19% |
| sugars | 8.99% |
| Liquid whole egg | 13.99% |
| Glucose syrup | 23.98% |
| Glycerol | 10.69% |
| Flavour | 0.10% |
| Soy fiber | 3.00% |
| salt | 0.21% |
| baking agents | 0.29% |
| Total before baking | 100.00% |

The starches contained native potato starch and pregelatinized corn starch.

To produce the cookie, a similar method was used to that detailed in Example 1. However, rather than coextruding the external and internal doughs, a “double sheeting” process was used. This involved sheeting the external dough in two parts through two different sheeting devices (an upper and lower device). The internal dough was then deposited on top of the lower sheeted dough, and the upper sheeted dough deposited on the internal dough.

The dual sheeted product was then cut in small pieces that were baked under conventional conditions. The Aw of the dual sheeted product was after equilibration 0.5. A crispy texture was noticeable on the upper crust while the dough centre remained soft during the whole shelf-life, creating a texture contrast.

The recipe of Example 4 could be adapted to include addition of fruit or vegetable extracts, such as powders, grits or flakes of tomato, carrot, spinach, leaks, chickpea, lentil, peas, beans and other pulses. Other plant extracts from grains, ancient grains and tubers such as wheat germ, rice bran, buckwheat grits or powder could also be added to the internal dough. The fiber contained in those plant extracts positively contribute to the water holding capacity requirement for the internal dough while imparting a natural wholesome aspect to the centre of the dual texture product.

### Example 5

A cookie was prepared without eggs. This recipe was found to provide a dual texture mouthfeel. The ratio between external and internal dough was the same as in Example 1.

In the external dough, liquid whole eggs were replaced by water, fat and sugars in the proportion indicated in the Table below

In the internal dough, liquid whole eggs were replaced by water, palm oil, starches and emulsifiers in the proportions indicated in the Table below.

| External Dough | wt % in dough |
|---|---|
| Wheat Flour | 37.25% |
| Fats | 15.65% |
| Dark chocolate chips | 14.90% |
| Sugars | 31.30% |
| Glucose syrup | 0.30% |
| Salt | 0.50% |
| Baking agents | 0.46% |
| Flavour | 0.10% |
| Water | 7.82% |
| Total before baking | 100.00% |

| Internal Dough | wt % in dough |
|---|---|
| Palm oil | 13.06% |
| Cocoa butter | 15.07% |
| Starches | 7.46% |
| Sugars | 14.67% |
| Glucose syrup | 24.11% |
| Glycerol | 10.75% |
| Flavour | 0.11% |
| Soy fiber | 3.0% |
| Salt | 0.50% |
| Baking agents | 0.22% |
| Emulsifier | 0.4% |
| Water | 10.65% |
| Total before baking | 100.00% |

The starches contained native potato starch and pregelatinized corn starch.

The process of production described in Example 1 was used. The added water corresponding to the amount contained in the liquid whole eggs was added together with the liquids (in phase 2 of mixing) while the fat (and emulsifiers), sugars and starches corresponding to the dry matter of liquid eggs was added as described in Example 1.

Straight after mixing, internal dough had a consistency comparable to Example 1.

During baking, the internal dough did not leak out the product. The final spread was similar to what was obtained in Example 1.

After equilibration of the product, a texture contrast was obtained.

### Comparative Example 1

A cookie was made with flour in both the inner and outer doughs. It was found that the presence of 12 wt % of wheat flour in the inner dough caused excessing spreading and internal dough leakage during baking. The ratios and the composition of the external dough are the same than in Example 1.

| Internal Dough | wt % in dough |
|---|---|
| Palm oil | 10.37% |
| Cocoa butter | 10.37% |
| Wheat Flour | 12.16% |
| Starches | 0.00% |
| Sugars | 15.55% |
| Liquid whole egg | 13.96% |
| Glucose syrup | 23.93% |
| Glycerol | 10.67% |
| Soy fiber | 2.19% |
| Salt | 0.50% |
| Baking agents | 0.29% |
| Total before baking | 100.00% |

Assessing the Dough Texture

F_{AV} Penetration Testing

In a penetration or puncture test, a probe is made to penetrate into the test sample and the force necessary to achieve a certain penetration depth or the depth of penetration in a specified time, under defined conditions, is measured and used as an index of hardness, firmness, toughness or some other textural property of the food.

A needle penetrates the sample at a pre-selected speed until a given strain. The force/penetration distance diagram is recorded from which the texture parameters defining the crispiness of the product are obtained and reported.

Measurements were taken with a Texture Analyzer equipped with a 30 kg-load cell, capable to perform the measurements with the parameter settings as defined in this method and an appropriate software package (e.g. Stable Micro Systems TA-XTPlus/2/i). Temperature and humidity were controlled in a cabinet at standard ambient levels.

The test settings were as follows:

| Test mode | Compression | |
|---|---|---|
| Pre-test | 1.0 | mm/s |
| speed | | |
| Test speed | 0.2 | mm/s |
| Post-test | 10.0 | mm/s |
| speed | | |
| Target mode | Strain | |
| Strain | 50% | |
| Trigger force | 20 | g |

From the test, the average force Fav (total energy divided by the penetration amplitude) was extracted.

For each sample, 10 measurements are done in the border of the biscuit and 10 measurements in the centre of the product (visible internal dough). The values in the table here under are an average value of the 10 measurements. The value represents the F_{AV} (average force) defined as the total energy needed to penetrate in the sample divided by the penetration amplitude.

The test was done on stabilized products aged of 3 months
Example N° 1 cookie made according to the disclosure
Example N° 3 made according to the disclosure
A Standard cookie (Crispy cookie without dual texture)
Industrials samples corresponding to Example 3 formula, aged 6 months, corresponding to the end of shelf-life.

| | F_{AV} value Internal | F_{AV} value External |
|---|---|---|
| | baked dough | baked dough |
| Example 1 | 3.6 ± 0.2 | 19.9 ± 5.9 |
| Example 3 | 4.6 ± 1.6 | 16.8 ± 1.5 |
| Example 3-aged 6 months | 2.7 ± 0.7 | 17.5 ± 4.1 |
| Std Granola Cookie | 10.5 | 11.6 |

As shown by these examples, these F_{AV} values, which characterize the force needed to penetrate into the sample, give us an indication about the hardness or the firmness of the baked dough. A high F_{AV} value would be representative of a hard texture that can be linked to hardness in bite, crispiness, crunchiness attributes. A low F_{AV} value will be representative of a soft dough offering less resistance to the mobile penetration.

All the cookie samples made according to the disclosure show a significant F_{AV} difference between the internal and the external dough, demonstrating the products' expected dual texture which is then retained after baking and upon storage

As a control, measurements were done on the standard Cookie which is a fully crispy product. The results show no difference between the border and the centre of the product.

Further Testing

Dough formulates were selected in order to illustrate both examples in accordance with the present disclosure.

Dough Compression Relaxation Testing

The dough was first characterized at room temperature by a classical compression test using a TAXT2 Texture Analyzer. This type of procedure is well-adapted for solid-like products like biscuit dough.

The dough was compressed between a plate and a cylinder of 1″ (2.54 cm) diameter, at a rate of 1 mm/s up to 80% engineering strain. This was followed by a 45 seconds relaxation phase. The parameters extracted from this test are:
The maximum force at the end of the compression Fmax (expressed in g)
The percentage of elasticity from the relaxation phase which is the ratio between the force at the end of the 45 seconds holding time vs F max, expressed in %:

% Elasticity=100×F₍ₜ₌₄₅₎/Fmax.

Values obtained for the different dough are given in the table below. STD is the standard deviation, based on about 10 replicates.

| | | | | % | |
|---|---|---|---|---|---|
| Dough type | Density | Fmax | STD | Elasticity | STD |
| External dough of Example 1 | 1.08 | 2790 | 90 | 8% | 1% |
| Internal dough of Example 1 | 0.97 | 1160 | 130 | 10% | 1% |
| Internal dough of Comparative | 0.96 | 420 | 70 | 6% | 1% |
| Example 1 | | | | | |
| Internal dough of Example 3 | 0.99 | 1100 | 80 | 11% | 1% |

The compression testing showed that the external dough is the stiffest and densest dough.

The control internal doughs (Examples 1 and 3) have a similar rheology. Removing starches and replacing them by flour, (see Comparative Example 1) leads to softer dough.

All doughs showed a very low elasticity level, close to 10%, indicative of “plastic behaviour” (the deformation remains after the force is removed), which is appropriate for a coextrusion process.

Small-Strain Oscillatory Measurements

Small-strain oscillatory measurements are carried out at a very low deformation (0.01%) and are therefore not disruptive. This allows the monitoring of dough rheological behaviour at rest while performing a temperature sweep, from 22° C. to 132° C. at a rate of 2° C./min, simulating baking.

The parameters extracted from the tests are the viscoelastic moduli G′ (Pa), the elastic modulus, indicative of the solid behaviour and G″ (Pa), the viscous modulus, indicative of the liquid behaviour.

A sample of 30 g of dough was inserted into a measuring cup of a MCR 500 rheometer (Anton Paar) equipped with a 6-wings Vane geometry that was slowly inserted into the measuring cup. The table below gives the values of the viscoelastic moduli of the different doughs straight after mixing. G′ and G″ are respectively the solid and liquid moduli and tan delta is the ratio G″/G′.

| Dough type | G′(t0) (Pa) | G″(t0) (Pa) |
|---|---|---|
| External dough of Example 1 | 5.6 × 10⁴ | 1.9 × 10⁴ |
| Internal dough of Example 1 | 3.9 × 10⁴ | 1.3 × 10⁴ |
| Internal dough of Example 3 | 2.4 × 10⁴ | 1.0 × 10⁴ |
| Internal dough of Comparative Example 1 | 2.0 × 10⁴ | 8.5 × 10³ |

The elastic modulus G′ is larger than the viscous one G″, indicating a solid-like behaviour, in agreement with practical observations.

The evolution during the 1 h lay time is relatively limited (Table 5): G′ increases by a factor about 2 and G″ by a factor about 1.5, indicating a strengthening of the solid-like behaviour. Indeed, tan-delta decreased from an average value of 0.40 to a value of 0.28.

| | Ratio | Ratio |
|---|---|---|
| Dough type | G′(1 h)/G′(T0) | G″(1 h)/G″(T0) |
| External dough of Example 1 | 1.46 | 1.20 |
| Internal dough of Example 1 | 1.89 | 1.25 |
| Internal dough of Example 3 | 2.35 | 1.61 |
| Internal dough of | 2.53 | 1.90 |
| Comparative Example 1 | | |

The dough samples were then heated up to 132° C. at a rate of 2° C./min. All doughs show the same sequence of events: upon heating, the elastic modulus first decreases with increasing temperature, due to the melting of solid fats and thinning of the continuous phase. Between about 60° C. and 100° C., the elastic modulus remains roughly constant while above 100° C., the elastic modulus increases again.

There were, however, significant differences between the doughs regarding the elastic modulus at room temperature and that at high temperature. The table below indicates the values of G′ at 20° C. and 90° C. for the doughs of the different Examples.

| Dough | G′(20° C.) | G′(90° C.) |
|---|---|---|
| External dough of Example 1 | 8.1 × 10⁴ | 617 |
| Internal dough of Example 1 | 5.7 × 10⁴ | 113 |
| Internal dough of Example 3 | 7.3 × 10⁴ | 279 |
| Internal dough of Comparative | 5.1 × 10⁴ | 1.5 |
| Example 1 | | |

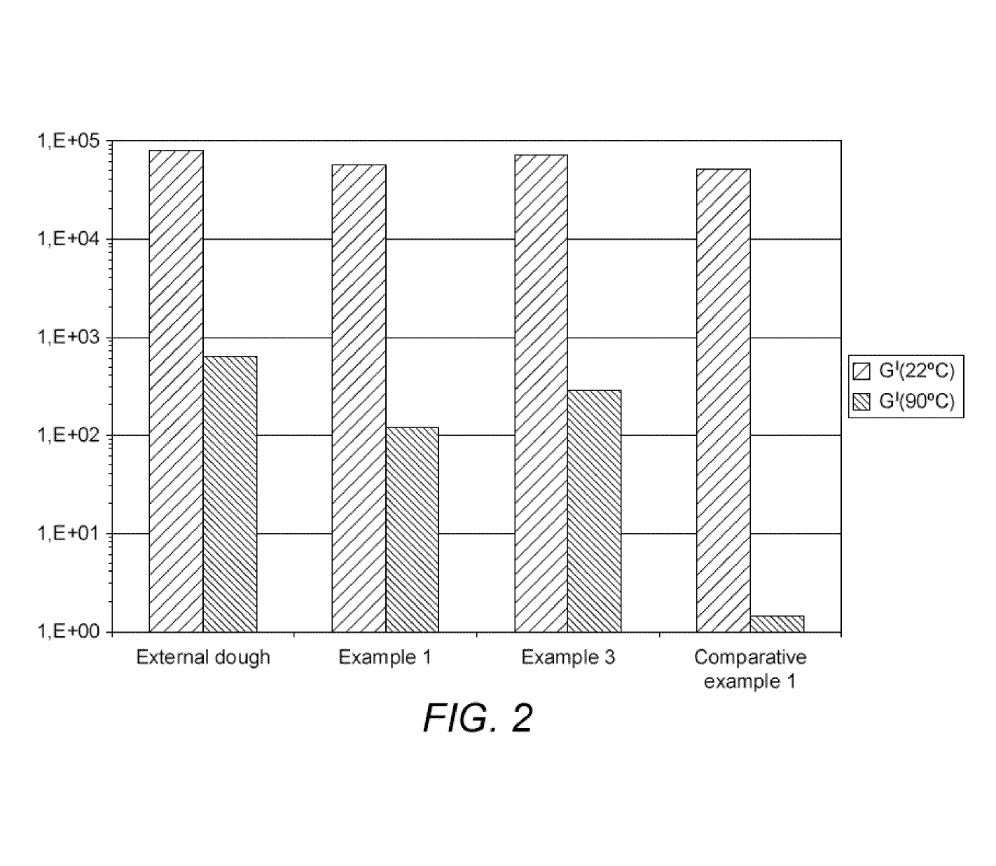

The results are shown in FIG. 2.

The inner dough of Comparative Example 1 has a very low elastic modulus value at 90° C., compared to the Examples 1 and 3. The difference is about two orders of magnitude. This marked thinning upon heating explains why the dough of Comparative Example 1 leaches out of the external dough during baking, leading to unacceptable products.

Since the cookie contains an inner and external dough, the final shape/spreading of the product may be influenced by the relative difference in between the two doughs rheology. The ratio of G′ for the inner dough vs the G′ for the external dough was calculated at different temperatures. The ratio values depend on the formulation. For Example 1, the ratio is above 0.1 while it is close to 0.05 for Example 3. A very low value 0.001 is obtained for dough Comparative Example 1. In this case, the inner dough was too fluid compared to the external dough and leaked out of the product, giving an unacceptable finished product.

Water Hydration Capacity (WHC) of Fibers

The test procedure was adapted from AACC 56-30.01, also described in Quinn and Paton (a practical measurement of the water hydration capacity of protein materials, Cereal Chem., 56, 38).

Fiber is dispersed in excess water and left to hydrate for 30 minutes with regular stirring. The dispersion was then centrifuged for 10 min at 2000 g. The supernatant was discarded and the pellet was weighed. Approximate water holding capacity WHC was calculated according to:

WHC=(mass pellet−mass tube−mass fiber)/mass fiber

WHC is the amount of water held per g of fiber (unit g/g). The procedure was applied to insoluble ingredients, i.e. soy fiber, cocoa powder and potato starch.

Soy fiber has the highest WHC, followed by cocoa powder and native potato starch.

| Ingredient | WHC |
|---|---|
| Soy fiber | 5.6 |
| Cocoa powder low fat | 2.2 |
| Potato starch | 0.76 |

As shown above, the swelling ability of fibers impacts dough rheology. In the dough of Example 1, 2.2% of soy fiber gave the same product as 5% of cocoa powder low fat. Without wishing to be bound by theory, it can be observed that the product of the concentration (in g fibers per g of dough) and the WHC of the fiber (g water by g of fiber) is comparable in both cases.

C×WHC=5×2.2=11 g water/100 g of dough for cocoa powder

C×WHC=2.2×5.6=12.3 g water/100 g of dough

The product “C×WHC” may indicate the amount of water than can be “held” by 100 g of dough, irrespective of the choice of the fiber.

Keeping C×WHC constant (at a value of 11), other swelling ingredients can be proposed as replacers for cocoa powders or soy fibers, for instance fibers contained in cereal brans or germs (rice, wheat), vegetables (carrot, leek, spinach), fruits (tomato, apple, citrus, banana), pulses (pea, lentils, beans and the like), tubers (potato and the like) and other plant materials.

It was found that by using the dual doughs discussed herein, it was possible to obtain a noticeable dual texture. This was perceptible to a sensory panel and could also be measured analytically by physical techniques, as discussed herein. Moreover, except where the doughs had different colours (such as cookies made from both plain and chocolate doughs) the cookies had no visible transition between the outside and inside of the cookie, which reinforces the impression of a “freshly-baked” texture. Thus, the cookie precursors described herein provide cookies having a soft centre and crunchy outer portion, i.e. the cookies have a dual texture.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

The disclosure will now be described in relation to the following non-limiting clauses:

1. A cookie precursor comprising a first dough mix and a second dough mix,
wherein the first dough mix comprises at least 20wt % of flour, and
wherein the second dough mix comprises 10 wt % or less of flour.

2. The cookie precursor according to clause 1, wherein the first dough mix comprises from 30 to 80 wt % flour, preferably from 30 to 50 wt %.

3. The cookie precursor according to clause 1 or clause 2, wherein the second dough mix comprises less than 5 wt % flour, preferably less than 1wt % flour and, more preferably, substantially no flour.

4. The cookie precursor according to any of the preceding clauses, wherein the second dough mix forms one or more discrete regions within the first dough mix.

5. The cookie precursor according to any of the preceding clauses, wherein the second dough mix is entirely encompassed by the first dough mix.

6. The cookie precursor according to any of the preceding clauses, wherein the cookie precursor is substantially disc-shaped.

7. The cookie precursor according to clause 6, wherein the cookie precursor has an outer peripheral portion comprising the first dough mix and an inner central portion comprising the second dough mix.

8. The cookie precursor according to any of the preceding clauses, the cookie precursor further comprising one or more regions of a third dough mix.

9. The cookie precursor according to any of the preceding clauses, wherein the ratio by weight of the first dough mix to the second dough mix is from 80:20 to 50:50.

10. The cookie precursor according to any of the preceding clauses, wherein the first dough mix further differs from the second dough mix by at least one of flavouring and/or colouring.

11. The cookie precursor according to any of the preceding clauses, wherein the first dough mix comprises:
fats in an amount of from 10 to 20 wt %; and/or
sugars in an amount of from 5 to 30 wt %, preferably from 20 to 30 wt %.

12. The cookie precursor according to any of the preceding clauses, wherein the second dough mix comprises:
fats in an amount of from 15 to 35 wt %, preferably from 15 to 25 wt %; and/or
sugars in an amount of from 10 to 25 wt %, preferably from 17 to 23 wt %; and/or oligosaccharides in an amount of 10 to 25 wt %, preferably from 17 to 23 wt %.

13. The cookie precursor according to any of the preceding clauses, wherein the second dough mix comprises cocoa butter in an amount of from 2 to 14 wt %, preferably from 8 to 14 wt %.

14. The cookie precursor according to any of the preceding clauses, wherein the first and/or second dough mixes comprise added sugars and added oligosaccharides.

15. The cookie precursor according to clause 14, wherein the first dough mix comprises added sugars in an amount of at least 80 wt %, preferably at least 90 wt %, more preferably at least 95 wt %, and preferably at most 99 wt %, by weight of the total added sugars and oligosaccharides in the first dough mix.

16. The cookie precursor according to clause 14 or clause 15, wherein the second dough mix comprises added sugars in an amount of less than 80 wt %, preferably less than 65 wt %, more preferably less than 55 wt %, and preferably at least 35 wt %, by weight of the total added sugars and oligosaccharides in the second dough mix.

17. The cookie precursor according to any of the preceding clauses, wherein the second dough mix comprises one or more starches and/or fibers, preferably in a total amount of from 5 to 20 wt %, more preferably from 10 to 20 wt %.

18. The cookie precursor according to clause 17, wherein the starches and/or fibers comprise native potato starch and pregelatinized corn starch, and/or soy fibers and/or cocoa powder.

19. The cookie precursor according to any of the preceding clauses, wherein the second dough mix comprises one or more humectants.

20. The cookie precursor according to any of the preceding clauses, wherein the second dough mix further comprises dried cheese powder, preferably in an amount of from 4 to 8 wt %.

21. The cookie precursor according to any of the preceding clauses, wherein the first and/or second dough mix further comprises a plurality of inclusions in an amount of from 5 to 25 wt %, preferably from 5 to 15 wt %, by weight of the dough mix, preferably selected from nuts, jellies, nougat, honeycomb, flavoured chips such as chocolate chips , coconut, toffee, oats, seeds, caramel, fudge, hard candy, marshmallows, cherries, raisins and dried fruit, or mixtures of two or more thereof.

22. The cookie precursor according to any of the preceding clauses, further comprising a topping in an amount of from 5 to 25 wt %, preferably from 5 to 15 wt %, by weight of the cookie precursor, wherein the topping is preferably selected from a glaze, a coating, such as a chocolate or yoghurt coating, nuts, jellies, nougat, honeycomb, oats, seeds, chocolate drops, toffee, fudge, hard candy, marshmallows, cherries, raisins and dried fruit, or mixtures of two or more thereof.

23. The cookie precursor according to any of the preceding clauses, wherein the ratio of the F_{AV} values of the first dough mix to the second dough mix is at least 3:1 and preferably from 3:1 to 8:1.

24. The cookie precursor according to any of the preceding clauses, wherein the second dough mix contains fibers in an amount such that the product of the amount by weight included in the second dough mix and the water hydrating capacity (WHC) of the fiber is at least 10.

25. The cookie precursor according to any of the preceding clauses, wherein the second dough mix comprises a fat blend having a Solid Fat Content of at least 20 wt %, preferably at least 30 wt %, and at most 60 wt % at 20° C.

26. A cookie obtainable by baking the cookie precursor of any of the preceding clauses.

27. The cookie according to clause 26, wherein the cookie is shelf stable for at least 6 months when stored at 20° C.

28. The cookie according to clause 26 or clause 27, wherein the cookie has an Aw of from 0.44 to 0.6.

29. The cookie according to any of clauses 26 to 28, wherein the cookie has a moisture content of from 5 to 9 wt %.

30. A method for forming a cookie precursor, the method comprising:
providing a first dough mix and a second dough mix,
forming a cookie precursor from the first and second dough mixes,
wherein the first dough mix comprises at least 20 wt % of flour, and
wherein the second dough mix comprises 5 wt % or less of flour.

31. The method according to clause 30, wherein the cookie precursor is according to any of clauses 1 to 25.

32. The method according to clause 30 or clause 31, wherein the first dough mix and the second dough mix are coextruded to form the cookie precursor.

33. The method according to any of clauses 30 to 32, the method further comprising baking the cookie precursor to form a cookie.

34. The method according to clause 33, wherein the method further comprises (i) applying a coating and/or filling to the cookie; and/or (ii) packaging the cookie.

According to an alternative embodiment there is provided a formulation containing an increased amount of flour in the inner dough compared to the embodiment of clause 1. In this embodiment the level of flour in the inner dough is lower than in conventional doughs, but still higher than that required by clause 1. It has been found that to some extent, the presence of starches and fibers may compensate for the presence of the flour and allow a softer centre to be retained, despite the flour content. This aspect is described in the following clauses:

35. A cookie precursor comprising a first dough mix and a second dough mix,
wherein the first dough mix comprises at least 20 wt % of flour, and
wherein the second dough mix comprises at most 20 wt % of flour and at least 5 wt %, preferably at least 8 wt %, of one or more starches and/or fibers.

36. The cookie precursor according to clause 35, wherein the starches and/or fibers comprise optionally modified native starches and/or optionally modified pregelatinised starches and/or soy fibers and cocoa powder.

37. The cookie precursor according to clause 35 or clause 36, wherein the second dough mix comprises from 10 to 18 wt % of flour.

38. The cookie precursor according to any of clauses 35 to 37, wherein the second dough mix comprises one or more starches and/or fibers in an amount of less than 20 wt %, preferably from 8 to 15 wt %.

It has surprisingly been found that the incorporation of starches and/or fibers into the second dough mix in the above-described amounts enables an increase in the flour content, without compromising the softness of the dough mix.

39. The cookie precursor according to any of clauses 1 to 25, wherein the second dough mix comprises fruit or vegetable extracts, plant extracts from grains, ancient grains and tubers. The fiber contained in those plant extracts positively contribute to the water holding capacity requirement for the internal dough while imparting a natural wholesome aspect to the centre of the dual texture product

Examples of fruit or vegetable extracts include powders, grits or flakes of tomato, carrot, spinach, leaks, chickpea, lentil, peas, beans and other pulses. Examples of plant extracts from grains, ancient grains and tubers include wheat germ, rice bran, buckwheat grits or powder.

40. The cookie precursor according to any of clauses 1 to 25, wherein the first and/or the second dough mix do not contain eggs.

1. A cookie precursor comprising a first dough mix and a second dough mix,
wherein the first dough mix comprises at least 20 wt % of flour, and
wherein the second dough mix comprises 10 wt % or less of flour.

2. The cookie precursor according to claim 1, wherein:
the first dough mix comprises from 30 to 80 wt % flour, preferably from 30 to 50 wt %; and/or
(ii) the second dough mix comprises less than 5 wt % flour, preferably less than 1 wt % flour and, more preferably, substantially no flour.

3. The cookie precursor according to claim 1, wherein the second dough mix forms one or more discrete regions within the first dough mix, and
preferably wherein the second dough mix is entirely encompassed by the first dough mix.

4. The cookie precursor according to claim 1, wherein the ratio by weight of the first dough mix to the second dough mix is from 80:20 to 50:50.

5. The cookie precursor according to claim 1, wherein the first dough mix comprises:
fats in an amount of from 10 to 20 wt %; and/or
sugars in an amount of from 5 to 30 wt %, preferably from 20 to 30 wt %.

6. The cookie precursor according to claim 1, wherein the second dough mix comprises:
fats in an amount of from 15 to 35 wt %, preferably from 15 to 25 wt %; and/or
sugars in an amount of from 10 to 25 wt %, preferably from 17 to 23 wt %; and/or
oligosaccharides in an amount of 10 to 25 wt %, preferably from 17 to 23 wt %.

7. The cookie precursor according to claim 1, wherein the second dough mix comprises one or more starches and/or fibers, preferably in a total amount of from 5 to 20 wt %, more preferably from 10 to 20 wt %.

8. The cookie precursor according to claim 7, wherein the starches and/or fibers comprise native potato starch and pregelatinized corn starch, and/or soy fibers and/or cocoa powder.

9. The cookie precursor according to claim 1, wherein the first and/or second dough mix further comprises a plurality of inclusions in an amount of from 5 to 25 wt %, preferably from 5 to 15 wt %, by weight of the dough mix, preferably selected from nuts, jellies, nougat, honeycomb, flavoured chips such as chocolate chips, coconut, toffee, oats, seeds, caramel, fudge, hard candy, marshmallows, cherries, raisins and dried fruit, or mixtures of two or more thereof, and/or
wherein the cookie precursor further comprises a topping in an amount of from 5 to 25 wt %, preferably from 5 to 15 wt %, by weight of the cookie precursor, wherein the topping is preferably selected from a glaze, a coating, such as a chocolate or yoghurt coating, nuts, jellies, nougat, honeycomb, oats, seeds, chocolate drops, toffee, fudge, hard candy, marshmallows, cherries, raisins and dried fruit, or mixtures of two or more thereof.

10. The cookie precursor according to claim 1, wherein the second dough mix comprises a fat blend having a Solid Fat Content of at least 20 wt %, preferably at least 30 wt %, and at most 60 wt % at 20° C.

11. A cookie obtainable by baking the cookie precursor of claim 1.

12. The cookie according to claim 11, wherein the cookie has a dual texture that is shelf stable for at least 6 months when stored at 20° C.

13. The cookie according to claim 11, wherein the cookie has an Aw of from 0.44 to 0.6, and/or
wherein the cookie has a moisture content of from 5 to 9 wt %.

14. A method for forming a cookie precursor, the method comprising:
providing a first dough mix and a second dough mix,
forming a cookie precursor from the first and second dough mixes,
wherein the first dough mix comprises at least 20 wt % of flour, and
wherein the second dough mix comprises 5 wt % or less of flour.

15. The method according to claim 14, wherein the cookie precursor comprises a first dough mix and a second dough mix, wherein the first dough mix comprises at least 20 wt % of flour, and wherein the second dough mix comprises 10 wt % or less of flour.

16. The method according to claim 14, wherein the first dough mix and the second dough mix are coextruded to form the cookie precursor.

17. A cookie precursor comprising a first dough mix and a second dough mix,
wherein the first dough mix comprises at least 20 wt % of flour, and
wherein the second dough mix comprises at most 20 wt % of flour and at least 5 wt %, preferably at least 8 wt %, of one or more starches and/or fibers.
